(19) United States
(12) Patent Application Publication
(10) Pub. No.: US 2014/0315005 A1
(43) Pub. Date: Oct. 23, 2014

(54) DOUBLE- OR MULTIPLY FIBROUS SHEET MATERIAL CONTAINING SUPERABSORBENT MATERIAL AND A METHOD FOR PRODUCING IT

(71) Applicant: SCA Hygiene Products AB, Göteborg (SE)

(72) Inventor: Anders Strålin, Torslanda (SE)

(21) Appl. No.: 14/367,665

(22) PCT Filed: Dec. 21, 2012
(86) PCT No.: PCT/SE2012/051478

§ 371 Date: Jun. 20, 2014

Related U.S. Application Data
(60) Provisional application No. 61/579,755, filed on Dec. 23, 2011.

(51) Int. Cl. A47K 10/16; B32B 27/10; B32B 37/16; B32B 5/26

(52) U.S. Cl. CPC A47K 10/16; B32B 5/26; B32B 27/10; B32B 37/16
USPC 428/212; 428/332; 442/335; 156/62.2

(57) ABSTRACT

A fibrous sheet material includes at least two plies that are bonded together. The fibrous sheet material contains a superabsorbent material in the form of a web of filaments having a diameter in the range between 1 and 40 μm. The web of superabsorbent filaments has a basis weight between 1 and 15 g/m² and is located between the plies. A method for applying a superabsorbent polymer to a fibrous sheet material produces a superabsorbent double- or multi-ply fibrous sheet material.

### TECHNICAL FIELD

The present disclosure refers to a double- or multi-ply fibrous sheet material having superabsorbent material applied between at least two plies. The present disclosure further refers to a method for applying a superabsorbent polymer to a fibrous sheet material. The fibrous sheet material may be a tissue paper or a nonwoven material.

### BACKGROUND

Superabsorbent polymers are used to enhance the absorbent capacity in absorbent articles like diapers, incontinence care articles, sanitary napkins etc. The superabsorbent polymers are mostly used in particulate form and are mixed with a fibrous matrix or applied as layers between fibrous layers. It would also be desired to enhance the absorbent capacity of fibrous sheet material, such as nonwoven materials and tissue paper, by means of superabsorbent polymers. There has however been a problem to find suitable techniques for applying superabsorbent polymers to such materials.

US 2008/0032014 discloses a superabsorbent printable composition which can be applied to sheetlike materials for food packaging, for packaging moisture-sensitive goods etc. The composition comprises superabsorbent polymeric particles, an organic water-insoluble binder and an organic solvent. The composition is applied to the substrate by printing, especially by gravure printing.

US 2008/0115898 discloses a tissue paper product containing superabsorbent material in powder form applied between two plies of tissue paper.

U.S. Pat. No. 4,855,179 discloses the production of nonwoven fibrous webs from an aqueous solution of a polymer composition that upon curing forms a superabsorbent material. The filaments are attenuated and dried by first and second air streams. The filaments are collected on a foraminous surface to form a web, which is cured. The thus formed superabsorbent web can be used in diapers, sanitary napkins, incontinence products, towels and tissue.

DE 101 52 291 discloses superabsorbent fibrils having a diameter less than 4 μm which can be used in absorbent articles like diapers and sanitary napkins. The fibrils are made by mixing the superabsorbent material with water to form a gel, which under pressure and at a temperature of 160 to 230° C. is mixed with supercritical carbon dioxide, is supplied to a spinning jet.

WO 99/63923 discloses an absorbent structure wherein a layer of superabsorbent granules is adhered to a surface of a fibrous absorbent structure using a water-based polymeric binder.

WO 01/22858 discloses a cleaning sheet comprising a layer of electret material and a layer of absorbent polymer fibers. The electret material is capable of cleaning and removing particulate material from a surface and comprises a plurality of electret fibers of thermoplastic material.

WO00/75427 discloses an absorbent composite comprising first and second strata comprising fibers and binder. The absorbent composite may also contain superabsorbent particles and superabsorbent fibers.

There is still a need for fibrous sheet materials, such as tissue paper or nonwoven materials, having an enhanced absorption capacity by means of superabsorbent polymers and methods for applying a superabsorbent material to a sheet fibrous material.

### SUMMARY

It is accordingly an object of the present disclosure to provide a fibrous material containing a superabsorbent material having improved absorption properties. According to the present disclosure the fibrous sheet material comprises at least two plies that are bonded together, said fibrous sheet material containing a superabsorbent material in the form of a web of filaments having a diameter in the range between 1 and 40 μm, said web of superabsorbent filaments having a basis weight between 1 and 15 g/m² and is located between said plies.

Said thin web of superabsorbent filaments may have a basis weight between 2 and 8 g/m².

Said fibrous sheet material may be a tissue paper and/or a nonwoven material.

At least one ply may be a tissue paper having a basis weight between 10 and 30 g/m², preferably between 16 and 24 g/m².

At least one ply may be a nonwoven material having a basis weight between 10 and 60 g/m².

The present disclosure further refers to an effective method for applying and attaching a superabsorbent material to a fibrous sheet material in order to enhance the absorbent capacity of the sheetlike fibrous material. The method comprises the steps of: spinning superabsorbent polymer filaments by extruding and attenuating an aqueous polymer solution into a hot air stream to produce filaments, laying down the filaments onto a first ply of fibrous sheet material, drying a curing the polymer to form a web of superabsorbent filaments on said fibrous sheet material, applying at least one second ply of fibrous sheet material on top of said first ply and laminating the at least two plies together to form a double- or multi-ply product having said web of superabsorbent filaments applied between said at least two plies.

A hotmelt adhesive or dispersion glue may be added to bond said layer of superabsorbent filaments to at least one ply of fibrous sheet material.

Said superabsorbent filaments and/or fragments of filaments may be added to said first ply of fibrous sheet material (1) in amount of between 1 and 15 g/m2.

Said fibrous sheet material may be tissue paper and/or nonwoven material.

### BRIEF DESCRIPTION OF THE DRAWINGS

FIG. 1 discloses schematically a process for applying a superabsorbent material to a sheet-like material.

### DETAILED DESCRIPTION OF PREFERRED EMBODIMENTS

The fibrous sheet materials used in the process of the present disclosure are mainly tissue paper or nonwoven materials.

A tissue paper is defined as a soft absorbent paper having a basis weight typically between 10 and 30 g/m². Its density is typically below 0.60 g/cm³, preferably below 0.30 g/cm³ and more preferably between 0.08 and 0.20 g/cm³.

The fibers contained in the tissue paper are mainly pulp fibers from chemical pulp, mechanical pulp, thermo mechanical pulp, chemo mechanical pulp and/or chemo thermo mechanical pulp (CTMP). The fibers may also be recycled fibers. The tissue paper may also contain other types of fibers enhancing e.g. strength, absorption or softness of the paper. These fibers may be made from regenerated cellulose or synthetic material such as polyolefins, polyesters, polyamides etc.

A nonwoven material is defined as a bonded fibrous or filamentous web product, in which the fibers or filaments are oriented in a random manner or with a certain degree of orientation. The fibers can be natural, e.g. wood pulp of the same type as used in tissue paper, cotton, jute, hamp, linen, sisal etc., or manmade, e.g. rayon, lyocell, polyolefins, polyesters etc. The fibers in a nonwoven material are bonded together by the use of different bonding techniques, such as heat-bonding, hydroentangling, binding agents etc.

Examples of nonwoven materials are hydroentangled (spunlace) webs, spunbond webs, meltblown webs, airlaid webs, bonded carded webs

Absorbency is a desired property for tissue paper and for many nonowoven materials, especially for wipes. Tissue paper and nonwoven materials have a limited absorbent capacity, which could be enhanced by the incorporation of superabsorbent materials. Superabsorbent polymers are water-swellable, water-insoluble materials capable of absorbing at least about 20 times its weight of water and aqueous liquids of different kind. Organic materials suitable for use as a superabsorbent material can include natural materials such as polysaccharides, polypeptides and the like, as well as synthetic materials such as synthetic hydrogel polymers. Such hydrogel polymers include, for example, polyacrylic acid and its salts, polymethacrylic acid and its salts, polyethylacrylic acid and its salts, polybutylacrylic acids and its salts, polymethacrylate, polyethylacrylate, polybutylacrylate, polymethylmethacrylate, partly hydrolyzed acrylamide, poly-AMPS (2-acrylamideo-2-methylpropane sulfonic acid) and copolymers thereof.

Other examples of hydrogel polymers include polyacrylamides, polyvinyl alcohol, polyvinyl pyridines, hydrolyzed acrylonitrile grafted starch, acrylic acid grafted starch, and isobutylene maleic anhydride copolymers and mixtures thereof. The hydrogel polymers are crosslinked to render the material substantially water insoluble.

The present disclosure relates to a method by which a superabsorbent polymer is effectively applied and attached to a fibrous sheet material. The method is further adapted to be run at high speeds.

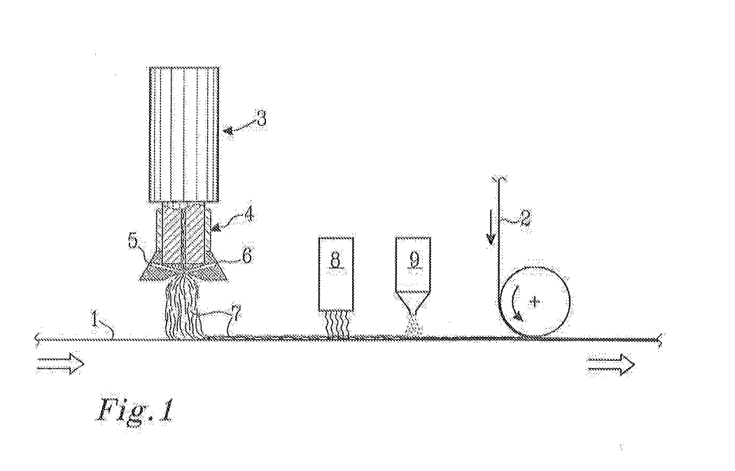

As illustrated in FIG. 1 a fibrous sheet material 1, such as a tissue paper or a nonwoven material, is forwarded to a superabsorbent filament extrusion device 3, for example a meltblowing apparatus. The method for spinning superabsorbent filaments involves supplying an aqueous polymer solution to the filament extrusion device 3, which may have any suitable design comprising a die head 4, through which the polymer solution is extruded into fine streams. These fine streams of polymer solution are attenuated by converging heated air streams of high velocity supplied from nozzles 5 and 6. The die head 4 preferably includes at least one row of extrusion apertures.

The polymer used for forming the superabsorbent filaments may be a homopolymer, for example a partially neutralized polyacrylic acid, or a copolymer of at least one alpha, beta-unsaturated carboxylic monomer and at least one monomer copolymerizable therewith, and a crosslinking agent, wherein the crosslinking functionality may comprise hydroxyl or heterocyclic carbonate groups. The copolymer may for example be a copolymer of partially neutralized acrylic acid and ethyl acrylate or butyl acrylate. The crosslinking agent may be ethylene carbonate, propylene carbonate, butylene carbonate, ethylene glycol, propylene glycol, 1,4-butanediol, diethylene glycol, glycerol, pentaerythritol, mesoerythritol or mixtures thereof.

The polymers used for forming super absorbent filaments may further be made of a terpolymer comprising monomers with carboxylic acids and salts thereof, monomers with a crosslinking function and monomers with a plasticizing effect.

Examples of carboxylic acid monomers are acrylic acid, methacrylic acid, ethyl acrylic acid, butyl acrylic acid. To facilitate a quick and high absorption the carboxylic acid monomers are partially neutralized to salts with ammonia, amine or alkali metal. To promote internal crosslinking with carboxylic acid groups at least some of the acrylic acid groups should be present as free acid groups.

An example of a group of crosslinking monomers is hydroxyl containing monomers that may form ester linkages with free carboxylic acid groups. Examples of monomers with hydroxyl groups are hydroxyethyl acrylate, hydroxypropyl acrylate, glyceryl acrylate, hydroxyethyl methacrylate, hydroxypropyl methacrylate or glyceryl methacrylate. At elevated temperatures ester crosslinks are formed between hydroxyl groups in the crosslinking monomer and free acid groups in the acrylic acid.

Plasticising monomers may also be used to facilitate processing and shaping of the polymer. The stiffness and flexibility of the filament is also improved which also result in a softer laminate. Examples of plasticizing monomers are methyl acrylate, ethyl acrylate, propyl acrylate, butyl acrylate, methyl methacrylate, ethyl methacrylate, butyl methacrylate 2-ethyl hexyl methacrylate.

The viscosity of the polymer solution is controlled by the solids content and the temperature of the solution to an appropriate level for the filament extrusion.

The polymer solution is attenuated to form filaments of microfiber size. Part of the filaments may be fragmented into filament fragments or fiber pieces. The filaments and filament fragments are laid down on the fibrous sheet material 1 and dried and crosslinked (cured) to form a thin layer of a random web 7 of superabsorbent filaments on the fibrous sheet material. After crosslinking the filaments are no longer water soluble. Crosslinking may be accomplished by heating, IR, microwaves, UV or e-beam. A crosslinking station 8 is indicated in FIG. 1. The crosslinking station 8 may be located before or after lamination to a further fibrous sheet material 2.

A preferred basis weight of said web 7 of superabsorbent filaments is in the range 1 to 15 g/m², preferably between 2 and 8 g/m². A suitable diameter of the filaments is in the range 1 to 40 μm and preferably in the range 1 to 10 μm. Some hotmelt adhesive or dispersion glue may be added, for example by a spray device 9, to bond the superabsorbent filament web 7 to one or both of the fibrous sheet material 1, 2.

The hotmelt adhesive or dispersion glue may be applied at different alternative locations, for example on the first fibrous sheet material 1 before applying the superabsorbent filaments thereon, or after applying the superabsorbent filaments, as shown in FIG. 1. Alternatively the hotmelt adhesive or dispersion glue is applied on a further second fibrous sheet material 2, referred to below, on the side thereof that will face the superabsorbent filaments. Hotmelt adhesive or dispersion glue may also be applied at two or more locations.

As an alternative or complement to applying a hotmelt adhesive or dispersion glue to bind the superabsorbent filaments to the fibrous sheet materials, water or water vapour may be added to increase the tackiness of the filaments.

A further layer of fibrous sheet material 2, for example tissue paper or nonwoven material, is laid on top of the first layer 1 of fibrous material and the superabsorbent filament web 7, so that the superabsorbent filament web 7 will be located between the two layers of fibrous sheet material 1 and 2. The layers 1, 2 and 7 are bonded together by steam, calendaring, hotmelt adhesive, dispersion glue or any other method used in conventional tissue paper or nonwoven ply bonding process.

Additional layers of superabsorbent filaments and fibrous sheet material may be added in a corresponding manner as described above. The final multi-ply product may also contain only one web of superabsorbent filaments and three or more layers of fibrous sheet material. The fibrous sheet materials in the double- or multi-ply product may be of the same or different types. As an example, a combination of tissue paper plies and nonwoven plies are feasible.

A typical basis weight for a tissue ply useful in a multi-ply product according to the present disclosure is in the range 10 to 30 g/m², preferably in the range 16 to 24 g/m². A typical basis weight for a nonwoven material useful in a multi-ply product according to the present disclosure is in the range 10 to 60 g/m².

Since the superabsorbent filaments are applied onto a sheet of fibrous material acting as a support layer, the web of superabsorbent filaments can be made very thin with a basis weight in the range 1 to 15 g/m². The thin web 7 of superabsorbent filaments provides an even distribution of the superabsorbent material over the area of the fibrous sheet material. The small fibre diameter of the superabsorbent filaments, in the range 1 to 40 μm, provides for a quick absorption compared with traditional superabsorbent material in particulate form. This together with the rapid liquid distribution obtained between the fibres in the tissue paper or nonwoven material will result in a quick and superabsorbing tissue or nonwoven composite.

A further advantage of using superabsorbent filaments in laminates comprising thin fibrous sheet materials, like tissue or nonwoven, is that the filaments do not penetrate these thin fibrous sheet, which may be the risk for superabsorbent material in particulate form.

The tissue or nonwoven composite according to the present disclosure may be converted in a known way to a suitable format, for examples rolls or folded wipes or towels.

### EXAMPLES

### Example 1

Laminates with tissue paper and superabsorbent filaments and for comparison laminates with tissue paper and superabsorbent particles were made according to the procedure described below. A through air dried tissue paper at 23×23 cm with a basis weight of 21 g/m² was sprayed with hot melt glue. The hot melt glue used was Dispomelt 6170 supplied by Henkel. As an average 8 g/m² hot-melt glue was sprayed onto the through air dried tissue sheets. The melt blown spray gun was supplied by Nordson and the glue was sprayed at 140° C. with an air supply temperature of 150° C. Superabsorbent filaments and for comparison super absorbent particles were evenly distributed onto a silicon treated release film inside a square of 23×23 cm. An amount of superabsorbent filaments or superabsorbent particles (0.45 g or 0.75 g) resulting in a superabsorbent web/layer of 8 or 14 g/m2 was used. The superabsorbent filaments or superabsorbent particles were picked up and glued to the tissue paper by gently pressing the pre-glued tissue above the superabsorbent filaments or particles. Another pre-glued tissue paper was then applied and pressed onto the tissue with glued superabsorbent filaments or superabsorbent particles. The superabsorbent filaments, 100C3180, were supplied by Technical Absorbents (Grimsby, UK) and had an average diameter of 29 μm. The superabsorbent particulate material, Hysorb B7160 S, was supplied by BASF (Ludwigshafen, Germany) and is a conventional grinded superabsorbent with a major superabsorbent fraction found in the interval 0.3-0.6 mm. In a similar way, a reference laminate without any superabsorbent material was produced.

The absorption was measured similar to the DIN absorption method, DIN 54540 part 4. As the intended use for the produced laminates is for wiping applications only short absorption times are relevant. For that reason the absorption time tested was 10 seconds instead of 60 seconds. For DIN absorption testing four samples at 10×10 cm were punched out from the laminate. The reported values of the 10 seconds DIN absorption are the average of four measurements from one laminate.

The results of the DIN absorption shown in Table 1 indicate an immediate absorption of water with the superabsorbent filaments. For the superabsorbent filaments the absorption capacity was increased by more than 100% as compared with the reference already after 10 seconds. For the comparison sample made with conventional grinded superabsorbent particles the absorption speed is much slower and the time required to reach a 100% increase in absorption capacity is too long for wiping applications. By using a web of superabsorbent filaments with a much greater surface area, a faster absorption can be obtained which will favor the function of superabsorbent tissue laminates for wiping applications.

TABLE 1
DIN absorption [g/g] of reference laminate, tissue-
SAP filament laminates and tissue-SAP particles laminates
at two different SAP (superabsorbent) loadings.

| | DIN absorption 10 s |
|---|---|
| | [g/g] |
| Reference | 6.9 |
| 8 g/m² SAP Filaments | 15.9 |
| 14 g/m² SAP Filaments | 17.3 |
| 8 g/m² SAP Particles | 8.6 |
| 14 g/m² SAP Particles | 9.5 |

### Example 2

Laminates 23×23 cm were produced according to the procedure described in Example 1. The wiping effect of produced laminates was tested by pouring deionized water at an amount corresponding 20 g/g of the tested wipe on to a tray. The tray measured 30×40 cm and had an edge wall height of about 15 mm. This edge secures that the water stays on the tray and is available for a second wipe. To study the wipe absorption efficiency and absorption speed, wiping was done for only 5 seconds followed by a weighing of the wipe to be able to calculate the wiping absorption in gram water absorbed per gram wipe. After weighing the wipe, another wiping of the remaining liquid on the tray was done. A second value of the wiping absorption representing a wiping at 5+5 seconds was then obtained. To get a figure of the total absorption capacity of the wipe, another weighing was made after the complete wipe was immersed into to deionized water for 60 seconds.

Results of the wiping absorption and total absorption capacity of the wipes are shown in Table 2 below. As the wiping absorption values after 5 seconds wiping are compared it is shown that the absorption of the laminates made with the superabsorbent filaments is faster than the laminates made with the superabsorbent particles despite the higher absorption capacity of the superabsorbent particles.

TABLE 2
Results of wiping absorption of water from tray after
5 seconds wiping, 5 + 5 seconds wiping and total
absorption after immersion for 60 second in deionized water.

| | 5 s Wiping | 5 + 5 s Wiping | +60 s Soaked |
|---|---|---|---|
| | Absorption | Absorption | Absorption |
| | [g/g] | [g/g] | [g/g] |
| Reference | 7.8 | 7.9 | 8.4 |
| Reference | 8.6 | 8.8 | 8.5 |
| SAP Filaments 8 g/m² | 11.8 | 15.9 | 19.4 |
| SAP Filaments 8 g/m² | 9.9 | 13.1 | 15.8 |
| SAP Filaments 14 g/m² | 10.1 | 14.9 | 19.6 |
| SAP Filaments 14 g/m² | 12.3 | 17.2 | 24.1 |
| SAP Particles 8 g/m² | 8.5 | 12.0 | 23.0 |
| SAP Particles 8 g/m² | 8.3 | 10.8 | 21.0 |
| SAP Paritcles 14 g/m² | 7.7 | 11.6 | 27.6 |
| SAP Particles 14 g/m² | 8.7 | 15.3 | 30.6 |

1. A tissue paper and/or a nonwoven material comprising at least two plies that are bonded together, said tissue paper and/or a nonwoven material containing a superabsorbent material, wherein the superabsorbent material is in the form of a web of filaments having a diameter in the range between 1 and 40 μm, said web of filaments having a basis weight between 1 and 15 g/m² and is located between said at least two plies.

2. A tissue paper and/or a nonwoven material as claimed in claim 1, wherein said web of filaments has a basis weight between 2 and 8 g/m².

3. (canceled)

4. A tissue paper and/or a nonwoven material as claimed in claim 1, wherein at least one ply of the at least two plies is a tissue paper having a basis weight between 10 and 30 g/m².

5. A tissue paper and/or a nonwoven material as claimed claim 1, wherein at least one ply of the at least two plies is a nonwoven material having a basis weight between 10 and 60 g/m².

6. A method for producing a tissue paper and/or a nonwoven material comprising at least two plies that are bonded together, said tissue paper and/or a nonwoven material containing a superabsorbent material, the method comprising: spinning superabsorbent polymer filaments by extruding and attenuating an aqueous polymer solution into a hot air stream to produce filaments, laying down the filaments onto a first ply of tissue paper and/or a nonwoven material, drying and curing said superabsorbent polymer to form a web of superabsorbent filaments on said tissue paper and/or a nonwoven material, applying at least one second ply of the issue paper and/or a nonwoven material on top of said first ply and laminating the first ply and the at least one second ply together to form a double- or multi-ply product having said web of superabsorbent filaments applied between said first ply and the at least one second ply.

7. A method as claimed in claim 6, further comprising adding a hotmelt adhesive or dispersion glue to bond said web of superabsorbent filaments to at least one of the first ply and the at least one second ply of the tissue paper and/or a nonwoven material.

8. A method as claimed in claim 6, further comprising applying said superabsorbent filaments to said first ply of the tissue paper and/or a nonwoven material in amount of between 1 and 15 g/m².

9. (canceled)

10. A tissue paper and/or a nonwoven material as claimed in claim 1, wherein at least one ply of the at least two plies is a tissue paper having a basis weight between 16 and 24 g/m².

11. A method as claimed in claim 6, further comprising applying said superabsorbent filaments to said first ply of the tissue paper and/or a nonwoven material in amount of between 2 and 8 g/m².
